(19) United States
(12) Patent Application Publication
(10) Pub. No.: US 2024/0181663 A1
(43) Pub. Date: Jun. 6, 2024

(54) QUICK CHANGE BLADE ASSEMBLY SYSTEM

(71) Applicant: CONAIR LLC, Stamford, CT (US)

(72) Inventors: Vito James CARLUCCI, Stratford, CT (US); Dennis COLPITTS, Fairfield, CT (US)

(73) Assignee: CONAIR LLC, Stamford, CT (US)

(21) Appl. No.: 18/073,826

(22) Filed: Dec. 2, 2022

(51) Int. Cl. B26B 19/06; B26B 19/38

(52) U.S. Cl. CPC B26B 19/06; B26B 19/3846

(57) ABSTRACT

A blade assembly including a bracket assembly that is connectable to a hair clipping appliance and a holder assembly that is connectable to a fixed clipper blade with the holder assembly being removably connectable to the bracket assembly.

### BACKGROUND

### 1. Field of the Invention

The present disclosure is related to hair clipping appliances. In particular, the present disclosure is related to a blade assembly for changing a blade of a hair clipping appliance.

### 2. Description of Related Art

Hair clipping appliances, for example, hair trimmers or clippers, are available that groom scalp hair and/or facial hair. The common style of hair clipping appliances have an adjustable taper control. The fixed cutting blade moves in relationship to the moving cutting blade on a bracket that slides in and out controlled by a taper lever arm. This is a fine adjustment for controlling the cut hair length. The fixed blade is screwed to the sliding bracket. The user typically adjusts the taper arm to the closest position and then loosens the two screws which has space to adjust the blade as closely as possible to the moving blade, so the clipper cuts as close as possible in this position. This is commonly known as zero gapping the blade. Also, there are blades that have different geometry that varies the cut length when they taper control slides up and down. Currently for a user to change the blade they must undesirably unscrew the blade replace it with the alternate blade and then make the adjustment to zero gap the blade.

Accordingly, it has been determined by the present disclosure that there is a continuing need for a device that overcomes, alleviates, and/or mitigates one or more of the aforementioned and other deleterious effects of prior devices.

### SUMMARY

The blade assembly of the present disclosure allows for a quick replacement of a blade on a hair clipping appliance and maintains the zero-gap adjustment on the same hair clipping appliance. It is also designed to be retrofit to existing models or used on new models of hair clipping appliances.

A blade assembly is provided including a bracket assembly that is connectable to a hair clipping appliance and a holder assembly that is connectable to a fixed clipper blade with the holder assembly being removably connectable to the bracket assembly.

The above-described and other features and advantages of the present disclosure will be appreciated and understood by those skilled in the art from the following detailed description, drawings, and appended claims.

### DESCRIPTION OF THE DRAWINGS

FIG. 1 is a bottom perspective view of a blade assembly according to the present disclosure having a holder assembly connected to a bracket assembly.

FIG. 2 is a bottom perspective view of the blade assembly of FIG. 1 having the holder assembly disconnected from the bracket assembly.

FIG. 3 is top perspective view of a blade holder of the holder assembly of FIG. 1.

FIG. 4 is bottom perspective view of the holder assembly of FIG. 1.

FIG. 5 is top perspective exploded view of the holder assembly and an assembly tool.

FIG. 6 is top perspective view of the bracket assembly of FIG. 1 having a locking lever in a connected position.

FIG. 7 is top perspective view of the bracket assembly of FIG. 1 having the locking lever in a disconnected position.

FIG. 8 is a partial top perspective view of the blade assembly of FIG. 1 connected to a hair clipping appliance and that has the holder assembly disconnected from the bracket assembly, and a taper arm of the hair clipping appliance being shown as adjusted to a close cutting position.

FIG. 9 is a top perspective view of the bracket assembly of FIG. 1 connected to the hair clipping appliance with parts removed illustrating the locking lever in the connected position and the disconnected position and the bracket assembly having a position when the taper arm of the hair clipping appliance is adjusted to a longest cutting position.

FIG. 10 is a bottom perspective view of the bracket assembly of FIG. 1 connected to the hair clipping appliance with parts removed illustrating the locking lever in the connected position and the disconnected position and the taper arm of the hair clipping appliance is shown as adjusted to the longest cutting position.

FIG. 11 is a partial top perspective view of the blade assembly of FIG. 1 connected to the hair clipping appliance and that has the holder assembly connected to the bracket assembly with a portion of a fixed clipper blade cut away, and the taper arm of the hair clipping appliance being shown as adjusted to the close cutting position.

FIG. 12 is a partial top perspective view of the blade assembly of FIG. 1 connected to the hair clipping appliance and that has the holder assembly connected to the bracket assembly, and the taper arm of the hair clipping appliance being shown as adjusted to the close cutting position.

FIG. 13 is a partial top perspective view of the blade assembly of FIG. 1 connected to the hair clipping appliance with the holder assembly disconnected from the bracket assembly, the holder assembly having a blade bracket that is modified to include a tab, and the taper arm of the hair clipping appliance being shown as adjusted to the longest cutting position.

FIG. 14 is a partial top perspective view of the blade assembly of FIG. 13 connected to the hair clipping appliance with the holder assembly connected to the bracket assembly, with a portion of a fixed clipper blade cut away, and with the taper arm of the hair clipping appliance adjusted to a closest cutting position.

### DETAILED DESCRIPTION

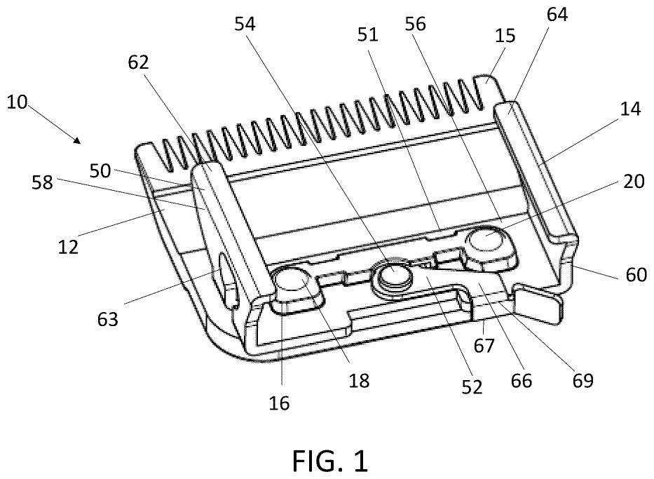

Referring to the drawings and in particular to FIG. 1, an exemplary embodiment of a blade assembly according to the present disclosure is shown and is generally referred to by reference numeral 10. Advantageously, blade assembly 10 allows for a quick replacement of a fixed clipper blade for hair clipping appliances, for example, hair trimmers or clippers, and maintains a zero-gap adjustment on the same hair clipping appliance. Blade assembly 10 is also designed to be retrofit to existing models or used on new models of hair clipping appliances.

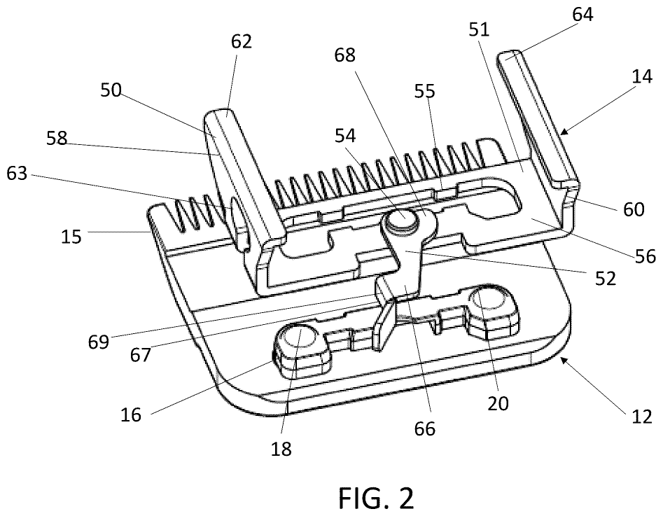

Referring to FIG. 2, blade assembly 10 has a holder assembly 12 and a bracket assembly 14. Holder assembly 12 has a fixed clipper blade 15, a blade holder 16, a first fastener 18 and a second fastener 20.

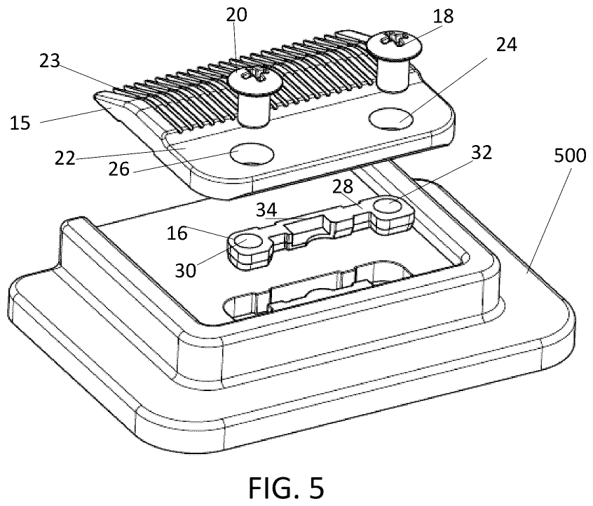

Referring to FIG. 5, fixed clipper blade 15 is a blade that has a blade body 22 with blades 23 extending from blade body 22 and openings 24, 26. For example, fixed clipper blade 15 can be a conventional fixed clipper blade.

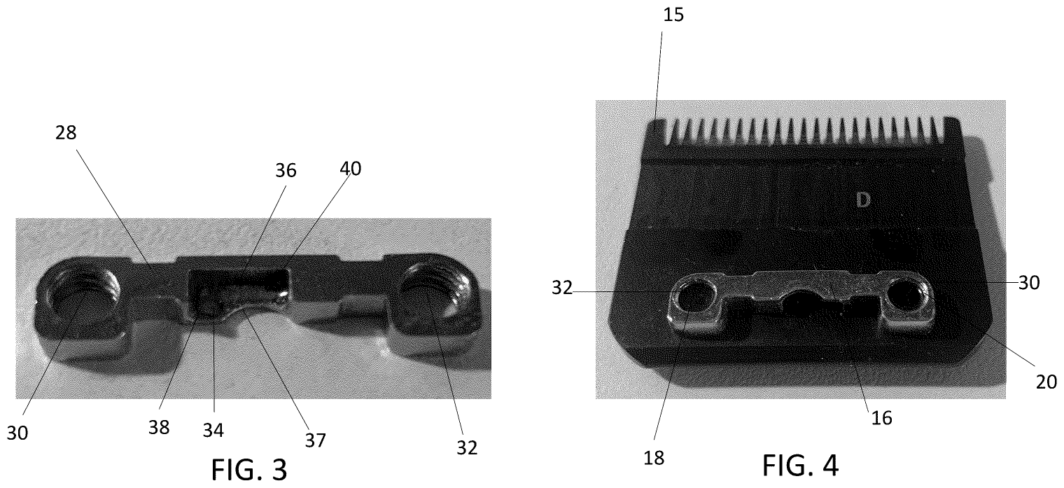

Referring to FIG. 3, blade holder 16 has a holder body 28. Blade holder 16 has openings 30, 32 that are, for example, tapped holes, through holder body 28 that are positioned to align with openings 24, 26 of fixed clipper blade 15 that receive first fastener 18 and second fastener 20. Blade holder 16 has a depression 34 in holder body 28 that forms a cam 36. Cam 36 can increase in thickness from a first side 38 to a second side 40 to form a ramp. Cam 36 has a notch 37.

Referring back to FIG. 5, first fastener 18 and second fastener 20, for example, are each a screw. Referring to FIG. 4, when assembled, first fastener 18 is through opening 24 of fixed clipper blade 15 and opening 32 of blade holder 16 and second fastener 20 is through opening 26 of fixed clipper blade 15 and opening 30 of blade holder 16 to fasten fixed clipper blade 15 to blade holder 16.

Referring to FIG. 5, an assembly tool 500 can optionally be used to assemble fixed clipper blade 15 to blade holder 16 by first fastener 18 and second fastener 20. For example, assembly tool 500 can hold blade holder 16 while fixed clipper blade 15 is positioned over blade holder 16 so that first fastener 18 can be inserted opening 24 of fixed clipper blade 15 and opening 32 of blade holder 16 and second fastener 20 can be inserted through opening 26 of fixed clipper blade 15 and opening 30 of blade holder 16 to fasten fixed clipper blade 15 to blade holder 16.

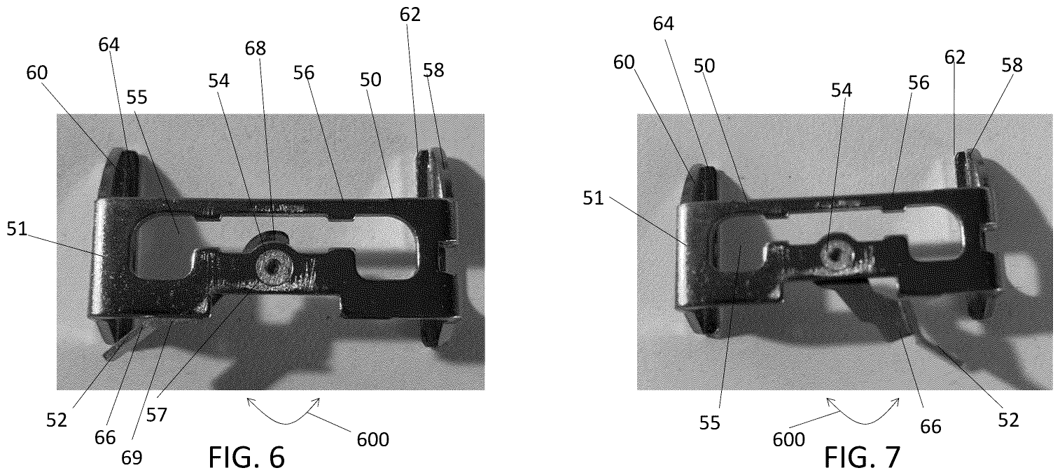

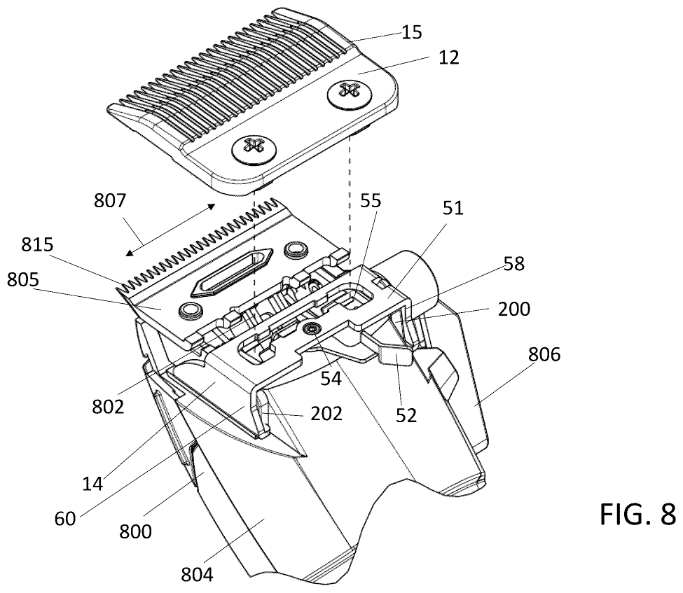

Referring back to FIG. 2, bracket assembly 14 has a blade bracket 50, a locking lever 52, and a rotatable fastener 54. Blade bracket 50 has a bracket body 51. Bracket assembly 14 has a cut out section 55 through bracket body 51 of blade bracket 50 that is shaped to receive blade holder 16. Bracket body 51 is bent to form a middle member 56 and side members 58, 60 on opposite sides of middle member 56 with each of side members 58, 60 forming a free end. The free end of side member 58 has a ridge 62 and the free end of side member 60 has a ridge 64. Ridges 62, 64 are bent inward towards one another. Middle member 56 has an opening 57 (FIG. 6) adjacent cut out section 55. Side member 58 has opening 63. Bracket body 51 can be different shapes while still forming cut out section 55. Locking lever 52 has locking lever arm 66 connected to locking lever tab 68. Locking lever arm 66 has a free end 67 opposite locking lever tab 68. Free end 67 is bent to form a fold 69. Locking lever 52 has an opening through locking lever arm 66. Rotatable fastener 54 is, for example, a rivet. Rotatable fastener 54 passes through the opening through locking lever arm 66 and opening 57 through blade bracket 50 to rotatably connect locking lever 52 to blade bracket 50 to form a pivot point for lever arm 52. Locking lever 52 is rotatable relative to blade bracket 50 as shown by arrows 600 between a connected position, as shown in FIG. 6, where a portion of locking lever tab 68 extends to overlap cut out section 55, and a disconnected position, as shown in FIG. 7, where locking lever tab 68 does not overlap and is outside of cut out section 55. As shown in FIGS. 1 and 6, when locking lever 52 is in the connected position, fold 69 of locking lever arm 66 abuts blade bracket 50 to limit further movement of locking lever 52.

Blade assembly 10 is connectable to hair clipping appliances, for example, hair trimmers or clippers having an adjustable taper control that moves a fixed cutting blade in relationship to a moving cutting blade as a fine adjustment for controlling the cut hair length.

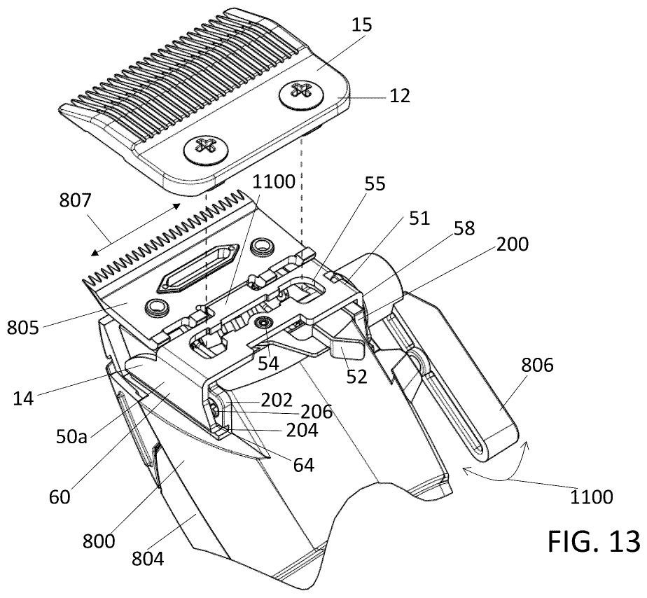

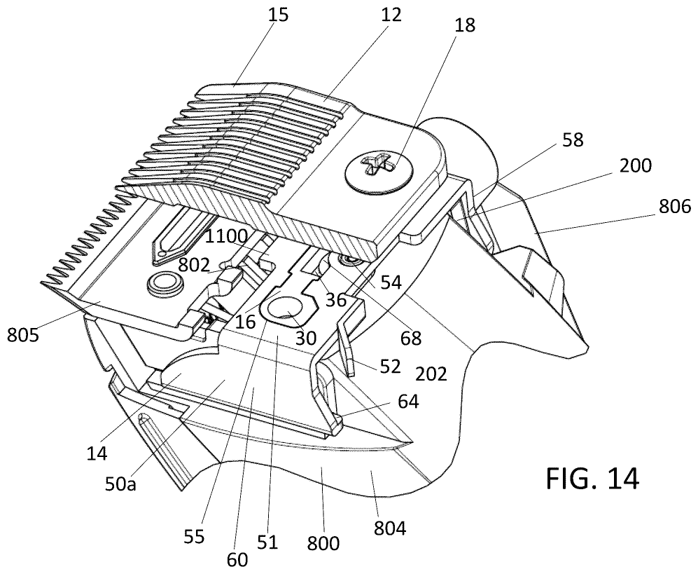

Referring to FIG. 8, bracket assembly 14 is connected to a hair clipping appliance 800 that is a hair clipper. Hair clipping appliance 800 has a blade driver 802 in a housing 804. Blade driver 802 is connected to a moving blade 805 to reciprocate moving blade 805 side-to-side in the directions shown by arrow 807 during use while fixed clipper blade 15 remains in a fixed position and does not move. Moving blade 805 has blades 815. Hair clipping appliance 800 has an adjustable taper control taper arm 806 (“taper arm 806”). Taper arm 806 is movable between a longest cutting position, as shown in FIG. 13, and a close cutting position, as shown in FIG. 8, as shown by arrows 1100.

Bracket assembly 14 is connectable to hair clipping appliance 800, for example, by a first plate 200 and a second plate 202 that are connected to housing 804 of hair clipping appliance 800. First plate 200 has a groove or track 201 and second plate 202 has a groove or track 204 (FIG. 13). First plate 200 can be connected to housing 804 by a screw or axle that is connected to taper arm 806 that passes through both an opening 819 of first plate 200 and an opening in housing 804. Second plate 202 can be connected to housing 804 by a screw 206 (FIG. 13) that passes through both second plate 202 and the opening through housing 804 that is positioned on a side on housing 804 that is opposite taper arm 806. As shown in FIG. 13, to connect bracket assembly 14 to hair clipping appliance 800, taper arm 806 is disconnected from hair clipping appliance 800 by disconnecting a screw that connects taper arm 806 to housing 804 and/or axle connected to taper arm 806, then ridge 64 of blade bracket 50 slides in track 204 of second plate 202 and ridge 62 of blade bracket 50 slides in track 201 of first plate 200, and the screw is then passed through taper arm 806, opening 63 of blade bracket 50, opening 819 of first plate 200, and housing 804 and/or the axle connecting blade bracket 50 and taper arm 806 to hair clipping appliance 800 to maintain bracket assembly 14 on hair clipping appliance 800. Referring back to FIG. 8, side members 58, 60 of blade bracket 50 are sized to provide space between blade bracket 50 and hair clipping appliance 800 for blade holder 16, rotatable fastener 54 and locking lever arm 66 to fit.

Alternatively, blade bracket 50 can be different shapes while still forming cut out section 55 so that blade bracket 50 is connected to hair clipping appliances, for example, by screws, adhesive, welding and any other connection.

Referring to FIGS. 2 and 8, when bracket assembly 14 is connected to hair clipping appliance 800, holder assembly 12 can be removably connected to bracket assembly 14 by positioning blade holder 16 that is connected to fixed clipper blade 15 through cut out section 55 of blade bracket 50 while locking lever 52 is in the disconnected position, as shown in FIG. 7, where locking lever tab 68 does not overlap and is outside of cut out section 55. Notch 37 can allow blade holder 16 to pass through cut out section 55 while locking lever 52 is in the disconnected position. After blade holder 16 is positioned through cut out section 55 of blade bracket 50, locking lever 52 is rotatable relative to blade bracket 50 from the disconnected position to the connected position, as shown in FIGS. 1, 6, 11 and 12, the action of rotating locking lever 52 from the disconnected position to the connected position engages lever tab 68 with an incline plane of cam 36 of blade holder 16 positioning fixed clipper blade 15 in a proper position and to pull fixed clipper blade 15 down tightly against blade bracket 50 so fixed clipper blade 15 will be locked in place, so that a deflection of a back side of blade bracket 50 provides tension to lock fixed clipper blade 15 in place. When holder assembly 12 is connected to bracket assembly 14, locking lever tab 68 is positioned in cam 36 to be between blade holder 16 and fixed clipper blade 15 to maintain the connection between holder assembly 12 and bracket assembly 14. Accordingly, fixed clipper blade 15 is quickly assembled to hair clipping appliance 800 without the use of tools.

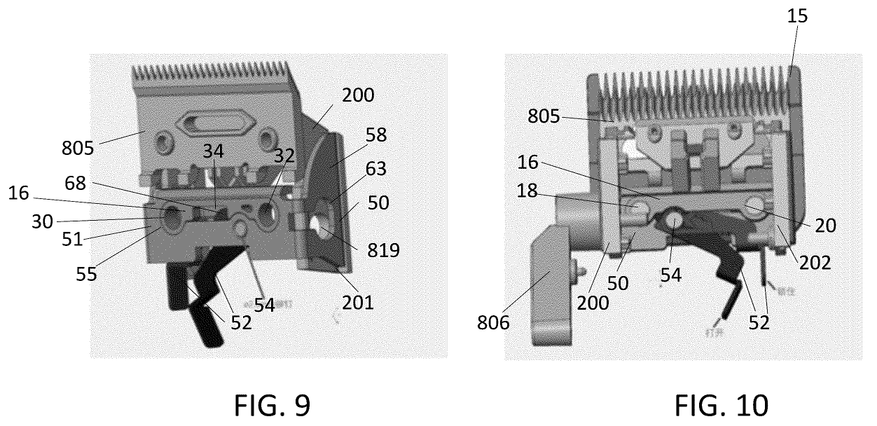

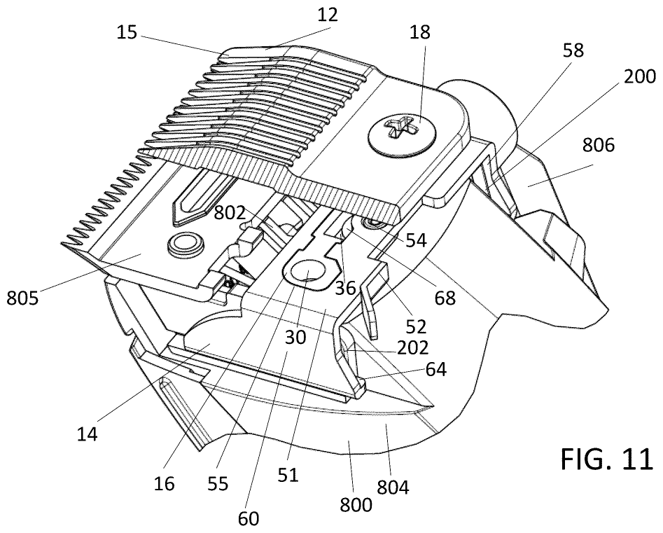

When connected to hair clipping appliance 800, fixed clipper blade 15 is movable in relationship to moving blade 805 on blade bracket 50 that can slide between the longest cutting position, as shown in FIGS. 9 and 13, and the close cutting position, as shown in FIG. 11, controlled by taper arm 806. Ridge 64 of blade bracket 50 slides in track 204 of second plate 202 and ridge 62 of blade bracket 50 slides in the track of first plate 200 when fixed clipper blade 15 is moved between the longest cutting position and the close cutting position. In the longest cutting position, taper arm 806 is positioned upward relative to the close cutting position, as shown in FIG. 13, and taper arm 806 is moved downward relative to the longest cutting position to the close cutting position, as shown in FIG. 11, to move fixed clipper blade 15 from the longest cutting position to the close cutting position. To move fixed clipper blade 15 from the close cutting position to the longest cutting position, taper arm 806 is moved upward relative to the close cutting position.

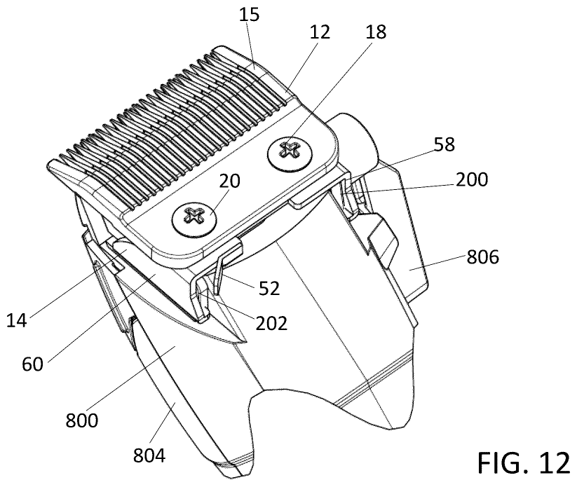

Referring to FIGS. 11 and 12, with taper arm 806 adjusted to the closest cutting position and locking lever 52 in the connected position, the user can loosen first fastener 18 to adjust first fastener 18 in opening 24 through fixed clipper blade 15 and/or opening 32 through blade holder 16 and the user can loosen second fastener 20 to adjust second fastener 20 in opening 26 through fixed clipper blade 15 and/or opening 30 through blade holder 16. Openings 24, 26, 30, and/or 32 can each be sized to allow movement of one of first fastener 18 or second fastener 20 therein to adjust fixed clipper blade 15 as closely as possible to moving blade 805, so hair clipping appliance 800 cuts as close as possible, for example, as close as possible to skin of a user, in this position. First fastener 18 and second fastener 20 can be retightened after this adjustment in their desired positions through openings 24, 26, 30, and/or 32 if desired. This is commonly known as zero gapping the blade. After fixed clipper blade 15 has been connected to hair clipping appliance 800 once and zero gapped, then fixed clipper blade 15 can be removed from blade bracket 50 and then reconnected to blade bracket 50 that remained connected to hair clipping appliance 800 without having to readjust the zero gap again.

Taper arm 806 can be removed with one screw. Once taper arm 806 is removed, blade bracket 50 can slide off the back hair clipping appliance 800. This makes blade assembly 10 easy to retrofit to existing hair clipping appliances.

Referring to FIG. 13, blade bracket 50 can be modified to blade bracket 50a that is the same as blade bracket 50 except blade bracket 50a has a tab 1100 that extends from a side of blade bracket 50a that is opposite to a side of blade bracket 50a connected to locking lever 52. With taper arm 806 adjusted to the longest cutting position (upward), as shown in FIG. 13, tab 1100 limits upward motion of moving blade 805, and, advantageously, tab 1100 will interact with blade driver 802 limiting the upward motion of moving cutting blade 805, so when fixed cutting blade 15 is removed it makes it easier to assemble back fixed cutting blade 15, or an alternative fixed cutting blade, onto blade bracket 50. In addition, advantageously, the position of moving cutting blade 805 is limited by motion of blade bracket 50a so that when fixed cutting blade 15 is assembled blade driver 802 will not touch tab 1100 that limits the upward motion of moving cutting blade 805. Moving cutting blade 805 has projections 809, 811 on a side opposite a blade side 812. Tab 1100 is positioned between projections 809, 811 so that tab 1100 can also limit the side-to-side movement of moving cutting blade 805 in the directions shown by arrow 807.

Advantageously, blade holder 16 can be attached to a fixed blade, for example, fixed clipper blade 15, of the user's choice and/or multiple blade holders 16 can each be attached to one of multiple fixed blades of the user's choice allowing bracket assembly 14 to remain fastened to hair clipping appliance 800 and for a quick removal and replacement of fixed clipper blades.

Accordingly, blade assembly 10 provides a quick change blade bracket, namely, bracket assembly 14, for the common style of hair clipping appliances that have an adjustable taper control for moving the fixed cutting blade in relationship to the moving cutting blade on a bracket that slides in and out as controlled by a taper lever arm. A blade holder with cam, namely, blade holder 16, can be attached to a blade of the users choice, for example, fixed clipper blade 15, and the blade holder, namely, blade holder 16, can be inserted into a cut out, namely, cut out section 55, in the sliding blade bracket, namely, blade bracket 50, with the locking lever arm, namely, locking lever 52, in the right position, as shown in FIG. 8, and then locked to the clipper by moving the locking lever, namely, locking lever 52 to the left position, as shown in FIG. 11, engaging blade holders cam, namely, cam 36, incline plane positioning the fixed clipper blade in the proper position and pulls it down tightly against the sliding blade bracket, namely, blade bracket 50, so the fixed clipper blade will be locked in place and the deflection of the back side of sliding blade bracket, namely, blade bracket 50, provides the tension to lock the fixed clipper blade in place. Also as described herein, when taper arm, namely, taper arm 806, is adjusted to the closest position and locking lever arm, namely, locking lever 52, is in the locked position the user can loosen the blade screws and adjust the two screws, namely, first fastener 18 and second fastener 20, which have space to adjust the fixed clipper blade as closely as possible to the moving blade, so the clipper cuts as close as possible in this position, which is commonly known as zero gapping the blade. The fixed clipper blade can be removed and then replaced without having to readjust the zero gap. Another advantage described herein is that the clippers taper arm, namely, taper arm 806, can be removed with one screw, once removed sliding blade bracket, namely, blade bracket 50, can slide off the back of the clipper making it easy for the quick-change bracket to be retrofitted to existing units.

It should also be noted that the terms “first”, “second”, “third”, “upper”, “lower”, and the like may be used herein to modify various elements. These modifiers do not imply a spatial, sequential, or hierarchical order to the modified elements unless specifically stated. Also, the term “attached” may also mean connected.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure is not limited to the particular embodiment(s) disclosed as the best mode contemplated, but that the disclosure will include all embodiments falling within the scope of the appended claims.

What is claimed is:

1. A blade assembly comprising:
a bracket assembly that is connectable to a hair clipping appliance; and
a holder assembly that is connectable to a fixed clipper blade, and the holder assembly being removably connectable to the bracket assembly.

2. The blade assembly of claim 1, wherein the fixed clipper blade can be adjusted to a position relative to a moving blade and the holder assembly can then be disconnected from the bracket assembly and then connected again to the bracket assembly positioning the fixed clipper blade in the same position relative to the moving blade when the holder assembly connects to the bracket assembly.

3. The blade assembly of claim 1, wherein the bracket assembly has a blade holder with a holder body and a depression in the holder body that forms a cam.

4. The blade assembly of claim 3, wherein the blade holder is removably connectable to the fixed clipper blade.

5. The blade assembly of claim 3, wherein the bracket assembly has a blade bracket connected to a locking lever by a rotatable fastener so that locking lever is rotatable relative to the blade bracket.

6. The blade assembly of claim 5, wherein the bracket assembly has a cut out section through a bracket body that is shaped to receive a blade holder of the bracket assembly.

7. The blade assembly of claim 6, wherein the bracket body is bent on opposite sides of a middle member to form a first side member and a second side member with each of the first and second side members forming a free end.

8. The blade assembly of claim 7, wherein the free end of the first side member has a first ridge and the free end of the second side member has a second ridge with the first ridge and the second ridge extending inward towards one another.

9. The blade assembly of claim 6, wherein the locking lever has locking lever arm connected to locking lever tab, so that locking lever is rotatable relative to the blade bracket between a connected position where a portion of the locking lever tab extends to overlap the cut out section, and a disconnected position where the locking lever tab does not overlap and is outside of cut out section.

10. The blade assembly of claim 8, wherein, to connect the bracket assembly to the hair clipping appliance, a taper arm is disconnected from the hair clipping appliance then the first ridge slides in a first track of a first plate connected to the hair clipping appliance and the second ridge slides in a second track of a second plate connected to the hair clipping appliance, and the screw is then passed through the taper arm, through an opening of the blade bracket, through an opening of the first plate, and the hair clipping appliance to maintain the bracket assembly on the hair clipping appliance.

11. The blade assembly of claim 5, wherein the blade bracket is connected to the hair clipping appliance by a connection selected from the group consisting of screws, adhesive, welding, and any combination thereof.

12. The blade assembly of claim 9, wherein the holder assembly is connected to the bracket assembly by positioning the blade holder that is connected to the fixed clipper blade through the cut out section of the blade bracket while the locking lever is in the disconnected position, and then the locking lever is rotated from the disconnected position to the connected position so that the lever tab engages with an incline plane of the cam of the blade holder and the locking lever tab is positioned in the cam to be between the blade holder and the fixed clipper blade.

13. The blade assembly of claim 12, wherein the rotating of the locking lever from the disconnected position to the connected position pulls the fixed clipper blade down tightly against the blade bracket so the fixed clipper blade is locked in place so that a deflection of a back side of the blade bracket provides tension to lock the fixed clipper blade in place.

14. The blade assembly of claim 1, wherein the fixed clipper blade is movable in relationship to a moving blade of the hair clipping appliance on a blade bracket of the bracket assembly that slides between a longest cutting position and the close cutting position controlled by a taper arm of the hair clipping appliance when connected to the hair clipping appliance.

15. The blade assembly of claim 14, wherein with the taper arm adjusted to the close cutting position and a locking lever of the bracket assembly in a connected position, a first fastener can be loosened to adjust the first fastener in a first opening through the fixed clipper blade and/or an opening through a blade holder of the bracket assembly and a second fastener can be loosened to adjust the fixed clipper blade relative to the moving blade.

16. The blade assembly of claim 1, wherein, when connected to the hair clipping appliance, a taper arm of the hair clipping appliance is removed, a blade bracket of the bracket assembly can slide off the hair clipping appliance.

17. The blade assembly of claim 5, wherein the blade bracket has a tab that extends from a side of the blade bracket that is opposite to a side of the blade bracket connected to the locking lever, and wherein when a taper arm of the hair clipping appliance is adjusted to a longest cutting position, then the tab limits upward motion of a moving blade of the hair clipping appliance.

18. The blade assembly of claim 1, wherein the fixed clipper blade is a plurality of fixed clipper blades, and wherein the holder assembly is a plurality of holder assemblies each having one of the plurality of fixed clipper blades so that the bracket assembly remains fastened to the hair clipping appliance while each of the plurality of holder assemblies can be connected and removed from the bracket assembly.

19. A bracket assembly comprising:
a blade bracket that is connectable to a hair clipping appliance; and
a locking lever connected to the blade bracket by a rotatable fastener so that the locking lever is rotatable relative to the blade bracket.

20. A holder assembly comprising:
a blade holder with a holder body and a depression in the holder body that forms a cam, the blade holder being connectable to a fixed clipper blade, the blade holder being removably connectable to a bracket assembly, and the bracket assembly being removably connectable to a hair clipping appliance.
